(19) United States
(12) Patent Application Publication
(10) Pub. No.: US 2018/0170784 A1
(43) Pub. Date: Jun. 21, 2018

(54) Filtering Annuli for Screw Press

(71) Applicants: Larry Baxter, Orem, UT (US); Skyler Chamberlain, Provo, UT (US); Jacom Chamberlain, Provo, UT (US); Kyler Stitt, Lindon, UT (US); Nathan Davis, Bountiful, UT (US)

(72) Inventors: Larry Baxter, Orem, UT (US); Skyler Chamberlain, Provo, UT (US); Jacom Chamberlain, Provo, UT (US); Kyler Stitt, Lindon, UT (US); Nathan Davis, Bountiful, UT (US)

(21) Appl. No.: 15/812,045

(22) Filed: Nov. 14, 2017

Related U.S. Application Data
(63) Continuation-in-part of application No. 15/385,056, filed on Dec. 20, 2016.

(51) Int. Cl. C02F 11/12; B01D 29/11; B01D 29/82; B01D 36/00

(52) U.S. Cl. CPC C02F 11/125; B01D 36/001; B01D 29/828; B01D 29/117

(57) ABSTRACT

Devices, systems, and methods for concentrating a slurry are disclosed. A concentrator is utilized, including a cylindrical vessel containing a cylindrical filter and a screw. The cylindrical filter consists of a plurality of spaced annuli. The screw passes through the cylindrical filter. A slurry passed through the cylindrical vessel is concentrated. The slurry is conveyed by the screw along an interior of the cylindrical filter. Any two concentric annuli are spaced such that the solid is prevented from passing between them. The slurry is concentrated to produce a concentrated slurry by restricting the product outlet such that a back pressure is created in the cylindrical vessel. The back pressure causes a portion of the liquid to pass between the annuli and out a fluid outlet. The concentrated slurry passes out a product outlet.

### RELATED APPLICATIONS

This application is a continuation-in-part of U.S. patent application Ser. No. 15/385,056, filed Dec. 20, 2016, which is hereby incorporated by reference herein in its entirety.

### GOVERNMENT INTEREST STATEMENT

This invention was made with government support under DE-FE0028697 awarded by the Department of Energy. The government has certain rights in the invention.

### FIELD OF THE INVENTION

The devices, systems, and methods described herein relate generally to separation of solids and liquids. More particularly, the devices, systems, and methods described herein relate to separations utilizing a screw press.

### BACKGROUND

Separations of solids and liquids is a challenge in nearly every industry. The challenge is greatly increased in cryogenic situations, where the solids involved are at extreme low temperatures and sublimate directly to gases at ambient pressures. Filter assemblies capable of handling these temperatures, maintaining higher pressure, and still effectively separating the solids and the liquids would be beneficial.

### SUMMARY

Devices, systems, and methods for concentrating a slurry are disclosed. A concentrator is utilized, including a cylindrical vessel containing a cylindrical filter and a screw. The cylindrical vessel includes a fluid inlet, a fluid outlet, and a product outlet. The cylindrical vessel has a first inner diameter and a longitudinal axis. The cylindrical filter consists of a plurality of spaced annuli. Each of the plurality of spaced annuli have a geometric center located on the longitudinal axis. Each of the plurality of spaced annuli have a second outer diameter and a second inner diameter. The second outer diameter is smaller than the first inner diameter such that a space between an outer side wall of the plurality of annuli and an inner wall of the cylindrical vessel forms a fluid plenum. The fluid outlet is adjacent to the fluid plenum. The screw passes through the cylindrical filter along the longitudinal axis. An outer edge of the screw has a first outer diameter. The first outer diameter is substantially the same as the second inner diameter such that the outer edge of the screw is adjacent to an inner side wall of the plurality of annuli without contact.

A slurry may be passed through the fluid inlet of the cylindrical vessel. The slurry may include a solid and a liquid. The slurry may be conveyed by the screw along an interior of the cylindrical filter. Any two concentric annuli of the plurality of spaced annuli may be spaced such that the solid is prevented from passing between any two concentric annuli of the plurality of spaced annuli. The slurry may be concentrated to produce a concentrated slurry by restricting the product outlet such that a back pressure is created in the cylindrical vessel. The back pressure causes a portion of the liquid to pass between any two concentric annuli of the plurality of spaced annuli into the fluid plenum and out the fluid outlet. The concentrated slurry may pass out the product outlet.

Any two concentric annuli of the plurality of spaced annuli may be spaced by a plurality of spacers between the two annuli. Any two concentric annuli of the plurality of spaced annuli may be spaced such that the solid in the slurry conveyed by the screw through the cylindrical filter is prevented from passing between any two concentric annuli of the plurality of spaced annuli.

The liquid may include water, hydrocarbons, liquid ammonia, liquid carbon dioxide, cryogenic liquids, or a combination thereof. The hydrocarbons may include 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

The solid may include carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, ore, microbes, precipitated salts, or a combination thereof.

The product outlet may be equipped with a plunger, the plunger restricting the product outlet. The plunger may have a heating element.

The back pressure may be created by a combination of a feed pressure of the slurry passing through the fluid inlet and a conveyance pressure on the slurry from the screw conveying the slurry through the product outlet.

The cylindrical vessel may have a gas outlet.

The plurality of spaced annuli may have a heating element.

The plurality of spaced annuli may have different thicknesses at the outer side wall and the inner side wall.

The plurality of spaced annuli may be made of stainless steel, carbon steel, brass, ceramics, plastics, polymers, or combinations thereof.

Any two concentric annuli of the plurality of spaced annuli may be spaced between 0.001 and 3 mm apart.

The method may be implemented by a computer that controls one or more motors, pumps, valves, heaters, coolers, actuators, or combinations thereof.

### BRIEF DESCRIPTION OF THE DRAWINGS

In order that the advantages of the described devices, systems, and methods will be readily understood, a more particular description of the described devices, systems, and methods briefly described above will be rendered by reference to specific embodiments illustrated in the appended drawings. Understanding that these drawings depict only typical embodiments of the described devices, systems, and methods and are not therefore to be considered limiting of its scope, the devices, systems, and methods will be described and explained with additional specificity and detail through use of the accompanying drawings, in which:

FIGS. 1A-H show various views of a concentrator device.

FIG. 2 shows an isometric front-bottom left view of an annulus that could be used in FIGS. 1A-G.

FIG. 3 shows a method for concentrating a slurry.

### DETAILED DESCRIPTION

It will be readily understood that the components of the described devices, systems, and methods, as generally described and illustrated in the Figures herein, could be arranged and designed in a wide variety of different configurations. Thus, the following more detailed description of the embodiments of the described devices, systems, and methods, as represented in the Figures, is not intended to limit the scope of the described devices, systems, and methods, as claimed, but is merely representative of certain examples of presently contemplated embodiments in accordance with the described devices, systems, and methods.

Separation of solids from liquids is a challenge, especially in cryogenic situations. Cryogenic separations are at extreme low temperatures, require stable above-ambient pressure, and should still effectively separate the liquids and solids. The devices, systems, and methods disclosed herein overcome these challenges. Further, the devices, systems, and methods disclosed herein are not limited to cryogenic situations. Rather, they can be used in general solid-liquid separations. Throughout this disclosure, the term “concentration” is used interchangeably with the terms “separation” and “thickening.” The devices, systems, and methods disclosed separate solids and liquids. In some instances, this is a substantially complete separation, resulting in a liquid-free or substantially liquid-free solid. In other instances, the separation involves a removal of only a portion of the liquids, commonly referred to as concentrating or thickening of the slurry. The term slurry includes any pastes or other solid-liquid mixtures.

Concentration herein involves the utilization of cross-flow filtration of a slurry conveyed by a screw. The cross-flow filter consists of a plurality of annuli, each spaced such that a small gap is made between consecutive annuli. This gap is chosen to prevent solids from passing through the gap, but allowing the liquids to pass through the gap. By providing a back pressure by restriction of the outlet at the end of the screw, a portion of the liquid is forced through the gaps, resulting in a concentrated slurry.

The use of a plurality of annuli rather than a typical porous filter plate has several immediately apparent benefits. The plates are much more easily constructed with tight specifications. Spacers can be used and their thicknesses varied to vary the gap widths with minimal costs. An overall larger surface area becomes available for liquid passage without losing solids through the gaps along with the liquid. Solid plates tolerate thermal cycling better than porous plates, especially when the plates are attached to other objects with different expansion and contraction coefficients. Other benefits will become apparent as the figures are detailed, below.

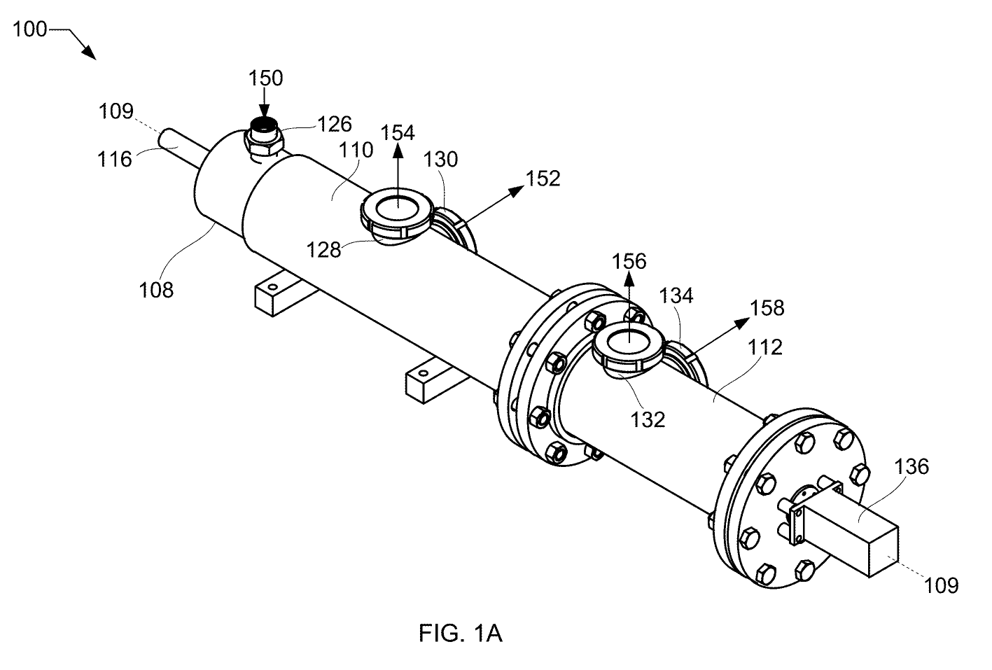

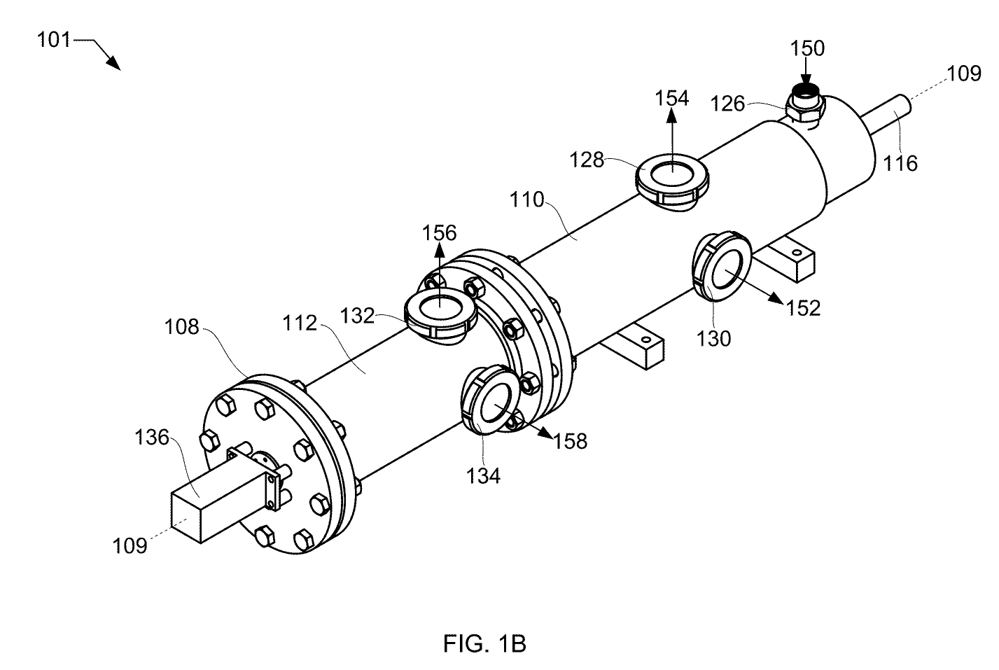

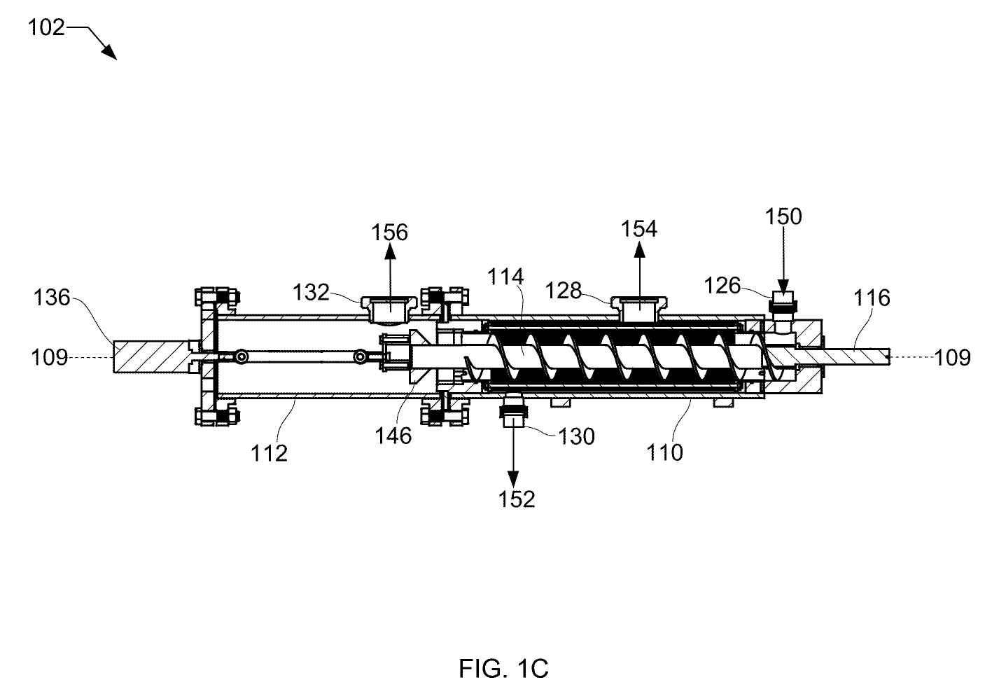

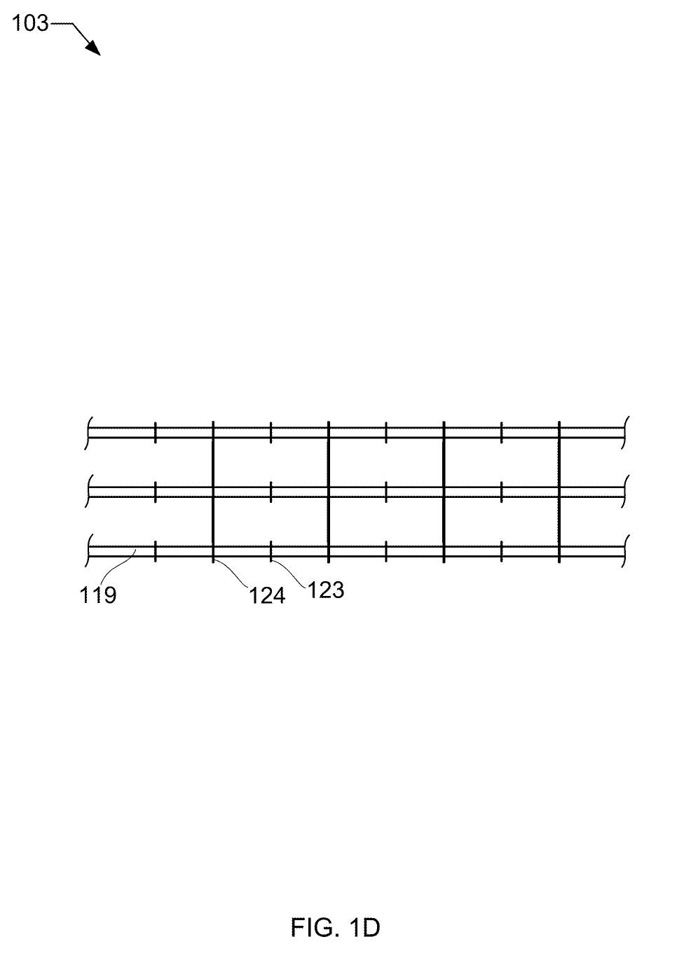

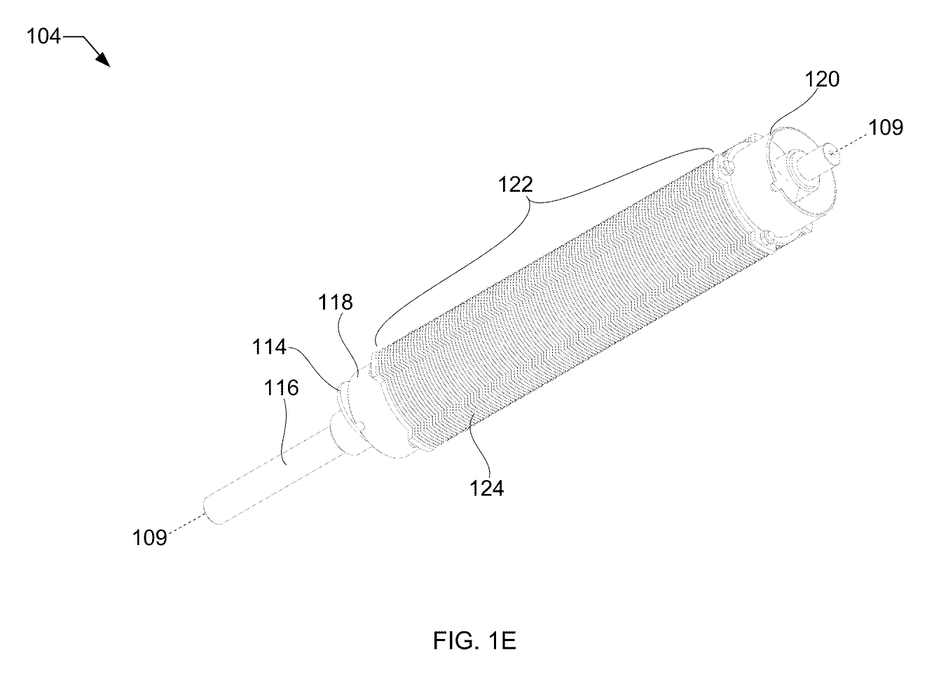

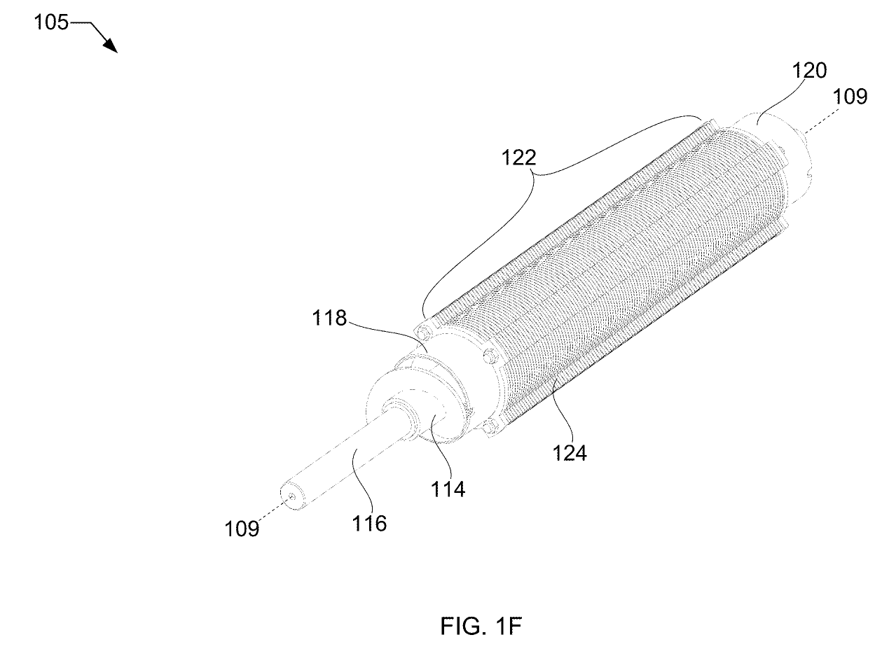

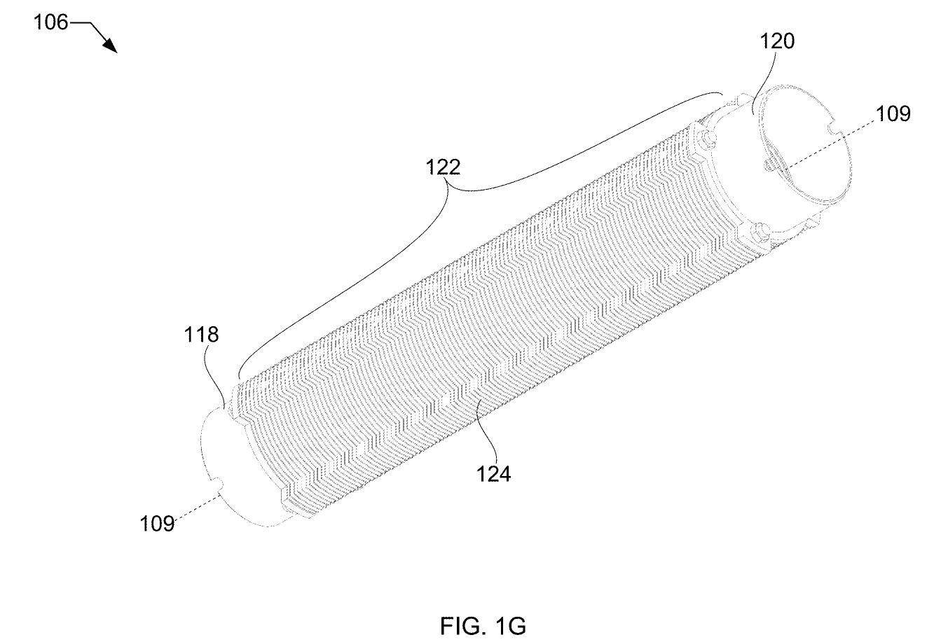

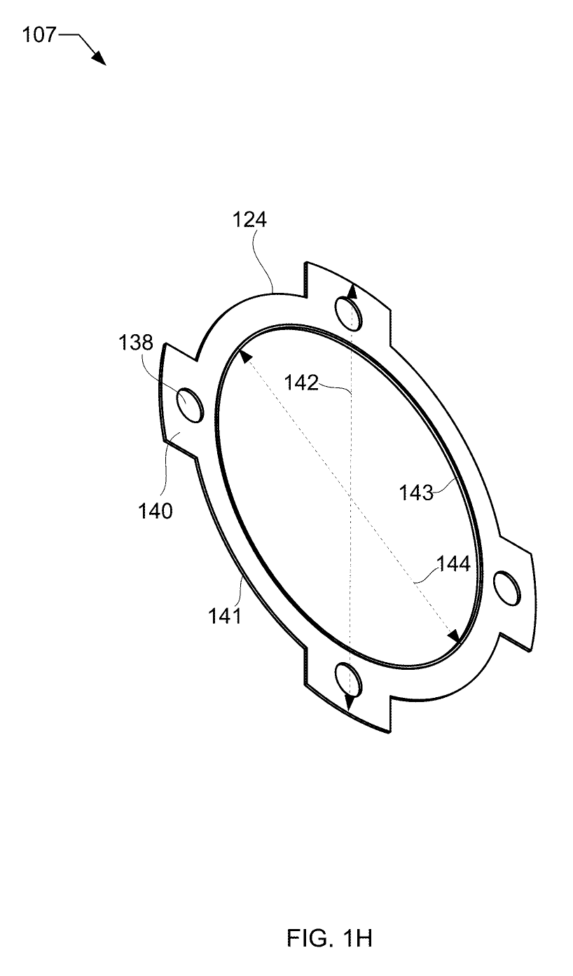

Referring now to the Figures, FIGS. 1A-H show various views 100-106 of a concentrator device 108 that may be used in the described devices, systems, and methods. FIG. 1A shows an isometric front, top-left view of the concentrator device at 100. FIG. 1B shows an isometric front, top-right view of the concentrator device at 101. FIG. 1C shows a cross-sectional side view of the concentrator device at 102. FIG. 1D shows an exploded side view of some of the plates of the cylindrical filter of the concentrator device, with associated spacers and rods, at 103. FIG. 1E shows an isometric front, bottom-left view of the cylindrical filter and screw of the concentrator device with the cylindrical vessel removed at 104. FIG. 1F shows an isometric back, top-right view of the cylindrical filter and screw of the concentrator device with the cylindrical vessel removed at 105. FIG. 1G shows an isometric front, bottom-left view of the cylindrical filter of the concentrator device with the cylindrical vessel and screw removed at 106. FIG. 1H shows an isometric view of one of the annular plates used in the cylindrical vessel at 107.

Cylindrical vessel 108 includes a filtering section 110 and a melting section 112. The filtering section 110 includes a fluid inlet 126, fluid outlets 130, a gas outlet 128, a screw 114, and a cylindrical filter 122. The screw 114 is rotated by a rotor 116. The cylindrical filter 122 consists of a plurality of annuli 124 separated by spacers 123 and held pressed together by end caps 118 and 120 and in place with rods 119. The annuli 124 have rod guide holes 138 as part of notches 140. Annuli 124 have an inner diameter 144 and an outer diameter 142, with an outer side wall 141 and an inner side wall 143. The outer diameter of the screw is substantially the same as the inner diameter 144 of the annuli 124 such that the outer edge of the screw is adjacent to the inner side wall 143 of the annuli 124 but does not contact the inner side wall 143. The melting section 112 acts as the product outlet for the filtering section 110. The melting section 112 includes a plunger 146 controlled by a piston 136, as well as a gas outlet 132, a liquid outlet 134, and a heating element (not shown). The outer shell of the filter section 110 has an inner diameter greater than the outer diameter 142 of the annuli 124. The space between the outer side wall 141 of the annuli 124 and the inside of the outer shell of the filter section 110 is a fluid plenum 146. The fluid outlets 130 are adjacent to the fluid plenum 146. In other embodiments, the annuli 124 are rings without notches.

A longitudinal axis 109 runs through the center of the rotor 116, and out through piston 136. The geometric center of the annuli 124 is along the longitudinal axis 109. The spaces between the annuli 124 in the cylindrical filter 122 are shown in FIGS. 1E-1G as being greater than would otherwise be present in this embodiment, as showing the annuli at their actual separation results in a black space in place of cylindrical filter 122. In some embodiments, the annuli 124 are spaced this far apart, but in the instance disclosed in this figure, the plates would be approximately 0.1 inches apart to prevent the solids in the slurry 150 from passing between neighboring annuli 124. In other embodiments, this spacing could be much smaller or much greater.

In this exemplary embodiment, the slurry 150 consists of a liquid, such as isopentane, and a solid, such as solid carbon dioxide. The slurry 150 passes through the fluid inlet 126 and is conveyed by the screw 114 through the cylindrical filter 122 to the melting section 112. The plunger 146 is moved in or out by piston 136 to maintain a back pressure inside the cylindrical filter 122. The back pressure causes a portion of the isopentane to pass through the spaces between the annuli 124 and into the fluid plenum 146. The portion of the isopentane 152, now substantially free of solid carbon dioxide, passes out the fluid outlets 130. Removal of the isopentane from the slurry 150 produces a concentrated slurry of solid carbon dioxide, which passes into the melting section past the plunger 146. The concentrated slurry is melted in the melting section 112 and leaves through liquid outlet 134 as liquid carbon dioxide 158. Any carbon dioxide gas 154 evolved in the filtering section 110 exits gas outlet 128. Any carbon dioxide gas 156 evolved in the melting section 112 exits gas outlet 132.

In another embodiment, no melter is used as the slurry consists of a liquid, such as water, and a solid, such as ore. Different ores have wildly different particle sizes. The gap between plates could therefore range from 0.001 mm to as high as 3 mm.

Referring to FIG. 2, FIG. 2 shows an isometric front-bottom left view 200 of an annulus that could be used in FIGS. 1A-G in place of annuli 124. The annulus 224 differs from annuli 124 in that the annulus 224 is round on the inner edge 243 and the outer edge 241. Second, annulus 224 has differing thicknesses on the inner edge 243 and the outer edge 241. In the embodiment shown, the inner edge 243 is thicker. The spacers between adjacent annuli 224 are still sized to keep the plates at a certain gap, but in this instance, that gap is only found at the inner edge 243. This pattern provides the gap size desired, but reduces pressure losses as the liquid passes into a larger gap as soon as it is separated from the solids.

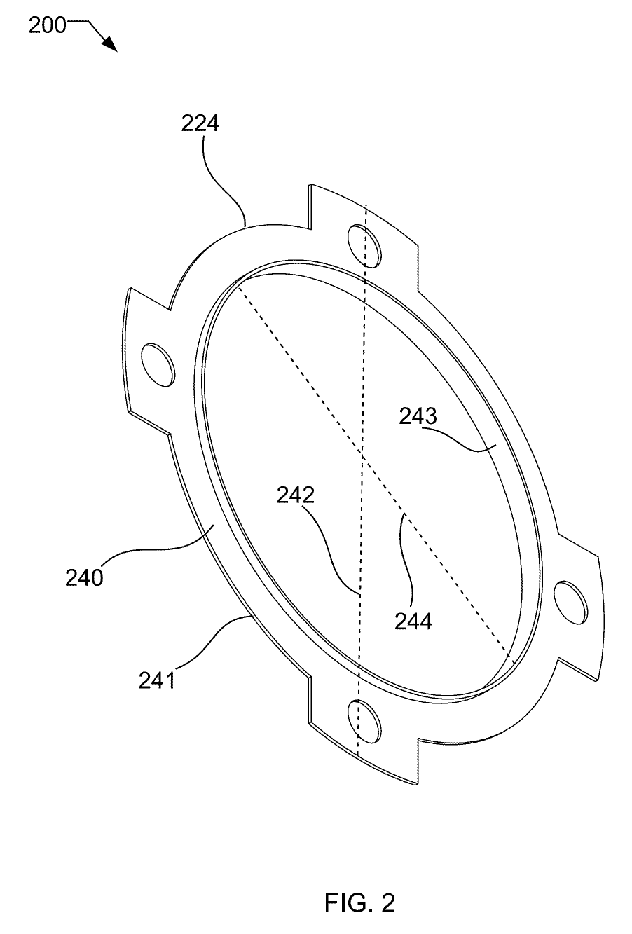

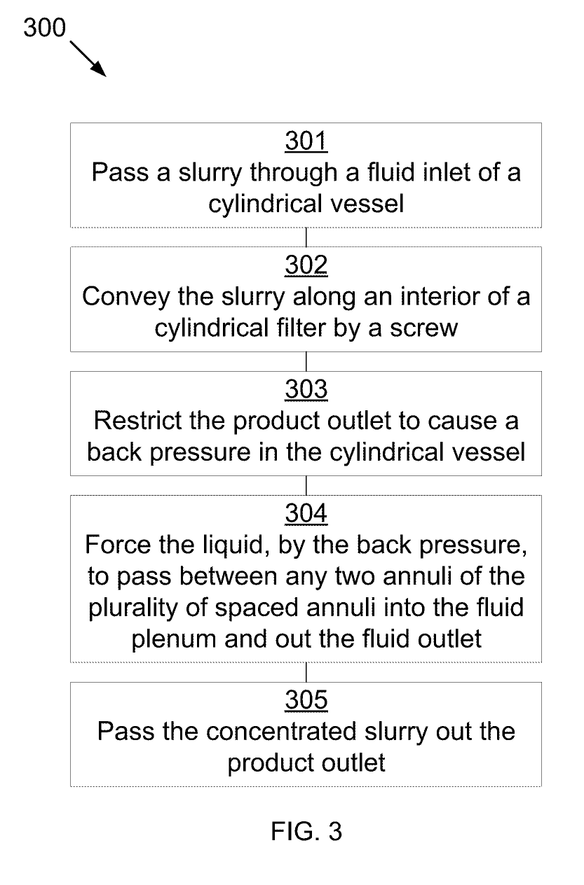

Referring to FIG. 3, FIG. 3 shows a method 300 for concentrating a slurry that may be used in the described devices, systems, and methods. A slurry, consisting of a solid and a liquid, is passed through a fluid inlet of a cylindrical vessel 301. The cylindrical vessel comprises the fluid inlet, a fluid outlet, and a product outlet. The cylindrical vessel has a first inner diameter and a longitudinal axis. The slurry is conveyed by a screw along an interior of a cylindrical filter 302. The cylindrical filter includes a plurality of spaced annuli. Each of the plurality of spaced annuli have a geometric center located on the longitudinal axis and each of the plurality of spaced annuli have a second outer diameter and a second inner diameter. The second outer diameter is smaller than the first inner diameter such that a space between an outer side wall of the plurality of annuli and an inner wall of the cylindrical vessel forms a fluid plenum, the fluid outlet being adjacent to the fluid plenum. Any two concentric annuli of the plurality of spaced annuli are spaced such that the solid is prevented from passing between any two concentric annuli of the plurality of spaced annuli. The screw passes through the cylindrical filter along the longitudinal axis, an outer edge of the screw having a first outer diameter. The first outer diameter is substantially the same as the second inner diameter such that the outer edge of the screw is adjacent to an inner side wall of the plurality of annuli without contact. The product outlet is restricted such that a back pressure is created in the cylindrical vessel 303. A portion of the liquid is forced by the back pressure to pass between any two concentric annuli of the plurality of spaced annuli into the fluid plenum and out the fluid outlet 304. In this manner, the slurry is concentrated. The concentrated slurry is passed out the product outlet 305. In some embodiments, method 300 is implemented by a computer that controls one or more motors, pumps, valves, heaters, coolers, actuators, or combinations thereof.

In some embodiments, the cylindrical vessel includes a fluid inlet, a fluid outlet, a product outlet, a cylindrical filter, and a screw. The cylindrical vessel has a first inner diameter and a longitudinal axis. The cylindrical filter has a plurality of spaced annuli. Each of the plurality of spaced annuli have a geometric center located on the longitudinal axis and each of the plurality of spaced annuli have a second outer diameter and a second inner diameter. The second outer diameter is smaller than the first inner diameter such that a space between an outer side wall of the plurality of annuli and an inner wall of the cylindrical vessel forms a fluid plenum. The fluid outlet is adjacent to the fluid plenum. The screw passes through the cylindrical filter along the longitudinal axis. An outer edge of the screw has a first outer diameter. The first outer diameter is substantially the same as the second inner diameter such that the outer edge of the screw is adjacent to an inner side wall of the plurality of annuli without contact.

In some embodiments, the liquid includes water, hydrocarbons, liquid ammonia, liquid carbon dioxide, cryogenic liquids, or a combination thereof. In some embodiments, the hydrocarbons include 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

In some embodiments, the solid includes carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, ore, microbes, precipitated salts, or a combination thereof.

In some embodiments, the product outlet includes a plunger, the plunger restricting the product outlet. In some embodiments, the plunger further comprises a heating element.

In some embodiments, the back pressure is created by a combination of a feed pressure of the slurry passing through the fluid inlet and a conveyance pressure on the slurry from the screw conveying the slurry through the product outlet.

In some embodiments, the cylindrical vessel has a gas outlet. In some embodiments, the slurry has entrained gases that separate from the slurry, pass between the annuli, and pass out the gas outlet.

In some embodiments, the plurality of spaced annuli have a heating element.

In some embodiments, the plurality of spaced annuli have different thicknesses at the outer side wall and the inner side wall. For example, the inner side wall may be machined to have raised edges that effectively reduce the gap available to liquid to pass between neighboring annuli. However, behind this raised edge, the annuli are smooth and a larger space is presented, allowing the passage of liquid to be unimpeded.

In some embodiments, the plurality of spaced annuli are made of stainless steel, carbon steel, brass, ceramics, plastics, polymers, or combinations thereof.

In some embodiments, any two concentric annuli of the plurality of spaced annuli are spaced between 0.001 and 3 mm apart.

In some embodiments, the cylindrical vessel is oriented horizontally. In other embodiments, the cylindrical vessel is oriented vertically, either facing up or down. In other embodiments, the cylindrical vessel is oriented at an angle between fully horizontal and fully vertical.

1. A concentrator device comprising:
a cylindrical vessel comprising a fluid inlet, a fluid outlet, and a product outlet, and wherein the cylindrical vessel has a first inner diameter and a longitudinal axis;
a cylindrical filter comprising a plurality of spaced annuli, wherein each of the plurality of spaced annuli have a geometric center located on the longitudinal axis and each of the plurality of spaced annuli have a second outer diameter and a second inner diameter, and wherein the second outer diameter is smaller than the first inner diameter such that a space between an outer side wall of the plurality of spaced annuli and an inner wall of the cylindrical vessel forms a fluid plenum, the fluid outlet being adjacent to the fluid plenum; and
a screw passing through the cylindrical filter along the longitudinal axis, an outer edge of the screw having a first outer diameter, wherein the first outer diameter is substantially the same as the second inner diameter such that the outer edge of the screw is adjacent to an inner side wall of the plurality of spaced annuli without contact.

2. The concentrator device of claim 1, wherein any two concentric annuli of the plurality of spaced annuli are spaced by a plurality of spacers between the two annuli.

3. The concentrator device of claim 1, wherein any two concentric annuli of the plurality of spaced annuli are spaced such that a solid in a slurry conveyed by the screw through the cylindrical filter is prevented from passing between the any two concentric annuli of the plurality of spaced annuli, the slurry further comprising a liquid.

4. The concentrator device of claim 3, wherein the slurry passes through the fluid inlet and is conveyed by the screw through the cylindrical filter to the product outlet, the product outlet being restricted such that a back pressure is created in the cylindrical vessel, and wherein the back pressure causes a portion of the liquid to pass between the any two concentric annuli of the plurality of spaced annuli into the fluid plenum and out the fluid outlet, and wherein removal of the portion of the liquid from the slurry produces a concentrated slurry, the concentrated slurry passing out the product outlet.

5. The concentrator device of claim 4, wherein the liquid comprises water, hydrocarbons, liquid ammonia, liquid carbon dioxide, cryogenic liquids, or a combination thereof.

6. The concentrator device of claim 5, wherein the hydrocarbons comprise 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

7. The concentrator device of claim 4, wherein the solid comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, ore, microbes, precipitated salts, or a combination thereof.

8. The concentrator device of claim 4, wherein the product outlet further comprises a plunger, the plunger restricting the product outlet.

9. The concentrator device of claim 8, wherein the plunger further comprises a heating element.

10. The concentrator device of claim 4, wherein the back pressure is created by a combination of a feed pressure of the slurry passing through the fluid inlet and a conveyance pressure on the slurry from the screw conveying the slurry through the product outlet.

11. The concentrator device of claim 1, wherein the cylindrical vessel further comprises a gas outlet.

12. The concentrator device of claim 1, wherein the plurality of spaced annuli have different thicknesses at the outer side wall and the inner side wall.

13. The concentrator device of claim 1, wherein the plurality of spaced annuli comprise stainless steel, carbon steel, brass, ceramics, plastics, polymers, or combinations thereof.

14. The concentrator device of claim 1, wherein any two concentric annuli of the plurality of spaced annuli are spaced between 0.001 and 3 mm apart.

15. A method for concentrating a slurry comprising:
passing a slurry, the slurry comprising a solid and a liquid, through a fluid inlet of a cylindrical vessel, the cylindrical vessel comprising the fluid inlet, a fluid outlet, and a product outlet, and wherein the cylindrical vessel has a first inner diameter and a longitudinal axis;
conveying the slurry by a screw along an interior of a cylindrical filter, wherein:
the cylindrical filter comprises a plurality of spaced annuli, wherein each of the plurality of spaced annuli have a geometric center located on the longitudinal axis and each of the plurality of spaced annuli have a second outer diameter and a second inner diameter;
the second outer diameter is smaller than the first inner diameter such that a space between an outer side wall of the plurality of spaced annuli and an inner wall of the cylindrical vessel forms a fluid plenum, the fluid outlet being adjacent to the fluid plenum;
any two concentric annuli of the plurality of spaced annuli are spaced such that the solid is prevented from passing between the any two concentric annuli of the plurality of spaced annuli; and
the screw passing through the cylindrical filter along the longitudinal axis, an outer edge of the screw having a first outer diameter, wherein the first outer diameter is substantially the same as the second inner diameter such that the outer edge of the screw is adjacent to an inner side wall of the plurality of spaced annuli without contact;
concentrating the slurry to produce a concentrated slurry by restricting the product outlet such that a back pressure is created in the cylindrical vessel, the back pressure causing a portion of the liquid to pass between the any two concentric annuli of the plurality of spaced annuli into the fluid plenum and out the fluid outlet;
passing the concentrated slurry out the product outlet.

16. The method of claim 15, wherein the any two concentric annuli of the plurality of spaced annuli are spaced by a plurality of spacers between the two annuli.

17. The method of claim 15, wherein the liquid comprises water, hydrocarbons, liquid ammonia, liquid carbon dioxide, cryogenic liquids, or a combination thereof.

18. The method of claim 17, wherein the hydrocarbons comprise 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

19. The method of claim 15, wherein the solid comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, soot, dust, minerals, ore, microbes, precipitated salts.

20. The method of claim 15, implemented by a computer that controls one or more motors, pumps, valves, heaters, coolers, actuators, or combinations thereof.
